(19) United States
(12) Patent Application Publication
(10) Pub. No.: US 2013/0047794 A1
(43) Pub. Date: Feb. 28, 2013

(54) SIMPLE STRUCTURE OF LOCKING PLIERS FOR RELEASING AND OPENING HANDLES AND JAWS THROUGH FAST AND DIRECT PULLING

(71) Applicant: JUI-YU HUANG, Taichung City (TW)

(72) Inventor: JUI-YU HUANG, Taichung City (TW)

(21) Appl. No.: 13/216,257

(22) Filed: Aug. 24, 2011

(51) Int. Cl. B25B 7/14

(52) U.S. Cl. 81/319

(57) ABSTRACT

A structure of locking pliers includes a movable joint pulling and pushing mechanism directly mounted to a tail end of a second handle. The mechanism includes a movable pulling bar forming a front-end arc recess that is positioned against a middle projection of a movable locking arm straddling between first and second handles of the pliers, so that the second handle can be pushed away by a reaction force to open and cause opening of jaws. The movable pulling bar can be simply pulled by a user to realize an easy push-to-open operation thereby achieving an effect that opening of the jaws is done by a pulling operation of the movable joint pulling and pushing mechanism that is arranged at a tail end of the second handle of the pliers to realize readily opening a clamping mouth of jaws.

### TECHNICAL FIELD OF THE INVENTION

The present invention generally relates to a simple structure of locking pliers for releasing and opening handles and jaws through fast and direct pulling, and more particularly to a control structure wherein a movable joint pulling and pushing mechanism is directly mounted to a tail end of a second handle of the pliers with the pulling and pushing mechanism comprising a movable pulling bar that directly pushes away an interconnection plate straddling between the first and second handles of the pliers to realize a fast operation for opening a clamping mouth of the two jaws at the front ends of the pliers.

### DESCRIPTION OF THE PRIOR ART

Conventional locking pliers have jaws formed at front ends thereof and the opening of the jaws is controlled by a push-to-open operation of a movable pushing bar arranged inside a second handle of the pliers. However, since the movable pushing bar is concealed in a recess of the second handle of the pliers and forms a small gap with respect to the second handle of the pliers, whereby when a user attempts to operate and pull the concealed movable pushing bar, due to the small gap, a finger of the user, which is often thicker than the gap, cannot be readily put into the gap between the second handle of the pliers and the movable pushing bar to pull the movable pushing bar. This is a major drawback of the conventional locking pliers.

Thus, the industry of hand tool provides a solution for such a problem, which comprises an improvement made on bending angle of the second handle of pliers and the movable pushing bar for the purposes of forming an expanded gap therebetween to allow the insertion of a user's finger. However, such an arrangement is simply a solution solely for overcoming the gap size problem and does not take into consideration of other factors, such as reduction of cost. This is certainly a problem.

### SUMMARY OF THE INVENTION

Thus, in view of the problems and drawbacks of the conventional locking pliers, the present invention aims to provide a simple structure of locking pliers for releasing and opening handles and jaws through fast and direct pulling in order to improve the operation performance of the locking pliers so as to overcome the problems associated with opening of two jaws of the pliers and to make the opening fast and simple.

An objective of the present invention is to provide a simple structure of locking pliers for releasing and opening handles and jaws through fast and direct pulling, wherein a push-to-open operation carried out by a movable locking arm that straddles between first and second handles of the pliers is controlled by a movable joint pulling and pushing mechanism that is directly mounted to a tail end of the second handle of the pliers. The pulling and pushing mechanism comprises a movable pulling bar that forms, in a front end thereof, an arc recess that is positioned against a middle projection of the movable locking arm straddling between the first and second handles of the pliers, so that the second handle can be pushed away by a reaction force to open and thus causing opening of the jaws, so as to fast and directly push for adjusting the push-to-open operation realized by the movable locking arm straddling between the first and second handles of the pliers thereby achieving an effect that opening of the jaws at front ends of the pliers is operated through being pushed by a pulling operation of the movable joint pulling and pushing mechanism that is arranged at a tail end of the second handle of the pliers to realize readily opening a clamping mouth of jaws.

Another objective of the present invention is to provide a control structure for fast pushing open two handles and jaws of locking pliers for fast opening, wherein a movable joint pulling and pushing mechanism is directly connected, through riveting, to a tail end of a second handle of the pliers, whereby the connection of the movable joint is realized through a two-sectioned riveting arrangement, so that parts are reduced to thereby realize both advantages of fast and easy operation and reduction of cost.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view, of locking pliers constructed in accordance with the present invention.

FIG. 2 is an exploded view of the locking pliers constructed in accordance with the present invention.

FIG. 3 is a plan view, partially broken, of the locking pliers constructed in accordance with the present invention.

FIG. 4 is a plan view, partially broken, illustrating an outward pulling operation of a movable pulling bar of a movable joint pulling and pushing mechanism mounted to a tail end of a second handle of the pliers according to the present invention;

FIG. 5 is a perspective view illustrating an opened condition of the pliers according to the present invention.

FIG. 6 is a plan view, partially broken, illustrating the opened condition of the pliers according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

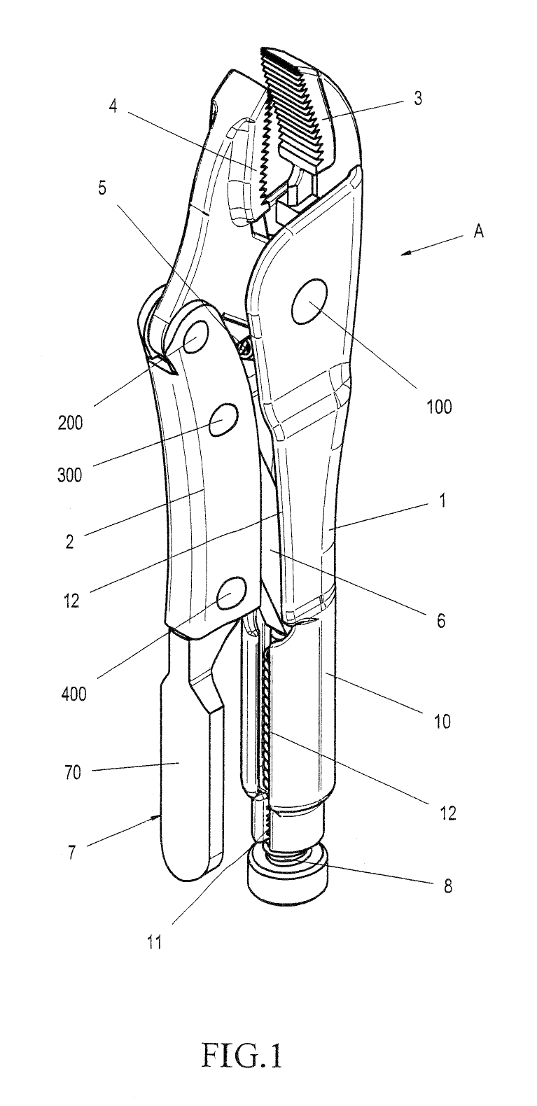

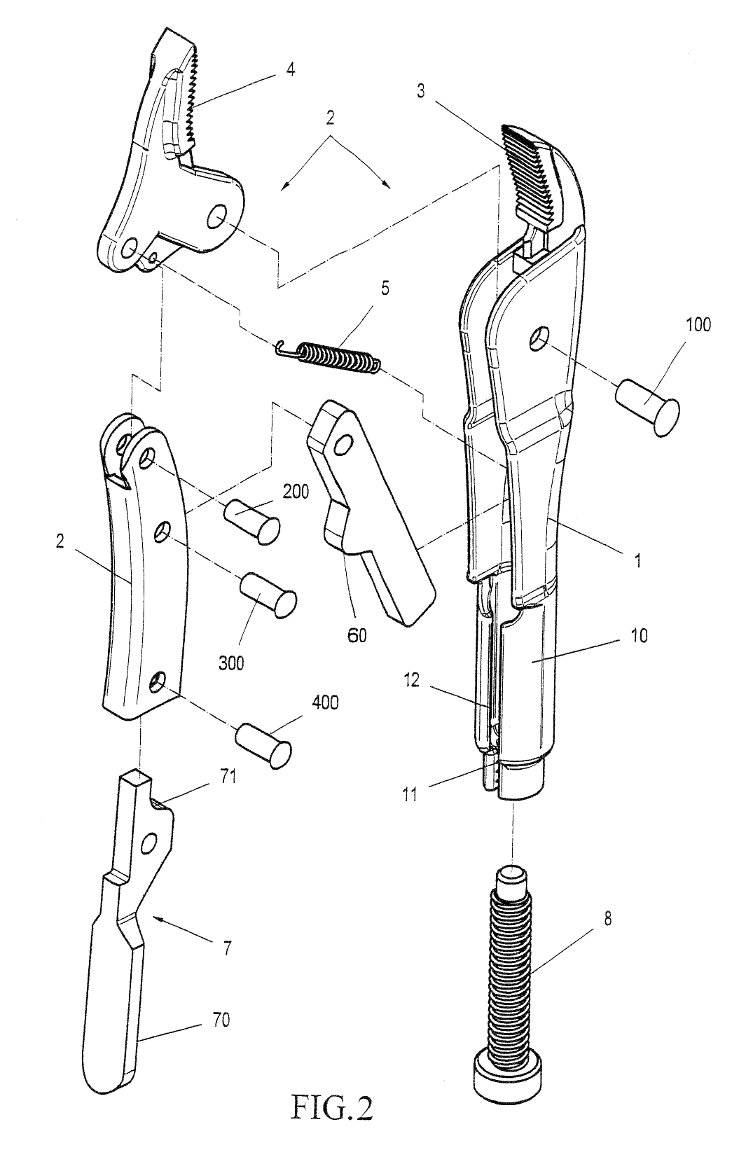

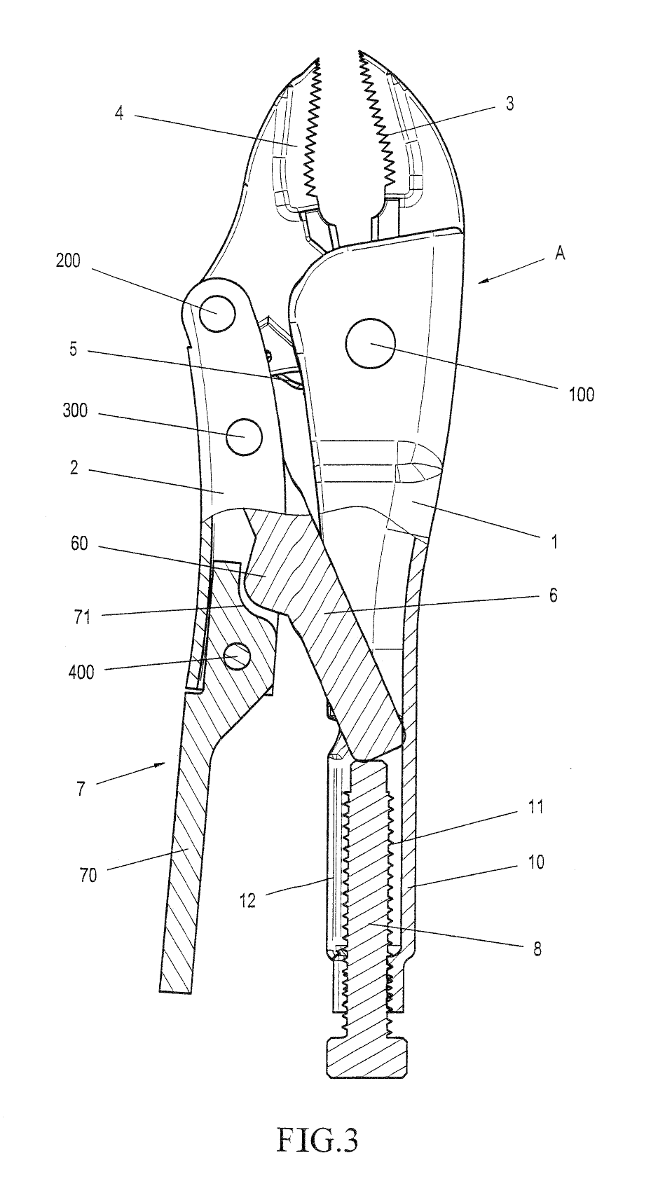

Referring to FIGS. 1, 2, and 3, which are respectively a perspective view, an exploded view, and a plan view, partially broken, of locking pliers A constructed in accordance with the present invention, the locking pliers A comprises first and second handles 1, 2, front end tips forming first and second jaws 3, 4, a tension spring 5, a movable lever serving as a locking arm 6 that straddles between the first and second handles 1, 2 of the pliers, a movable joint pulling and pushing mechanism 7 that is riveted to a tail end of the second handle of the pliers, and an adjusting bolt 8 that is mounted to a cylindrical grip section 10 of the first handle 1. The first handle 1 of the pliers A has a front end that is mounted by a rivet 100 and is fixed to the first jaw 3 through a stamped mounting spot to form a one-piece combined structure and has a tail end that forms the cylindrical grip section 10 that has an inside circumference forming a threaded bore 11 extending therethrough. The threaded bore 11 threadingly engages the adjusting bolt 8.

The second handle 2 of the pliers A has a front end that is fixed to the second jaw 4 by a flat-head rivet 200 to form a movable end structure. The second jaw 4 has an end to which the tension spring 5 is attached. The tension spring 5 has an opposite end that is attached to the first handle 1 to form a pulling state therebetween.

The movable locking aim 5 straddling between the first and second handles 1, 2 of the pliers has an end that is rived by a flat-head river 300 to the second handle 2 to form a movable joint structure, while an opposite end of the movable locking arm 6 is received in a sideway slit 12 that is formed in a radial side surface of the first handle 1 of the pliers and is supported on a tip end of the adjusting bolt 8 that is threadingly received and retained in the threaded bore 11 of the cylindrical grip section 10 formed in the tail end of the first handle 1 of the pliers.

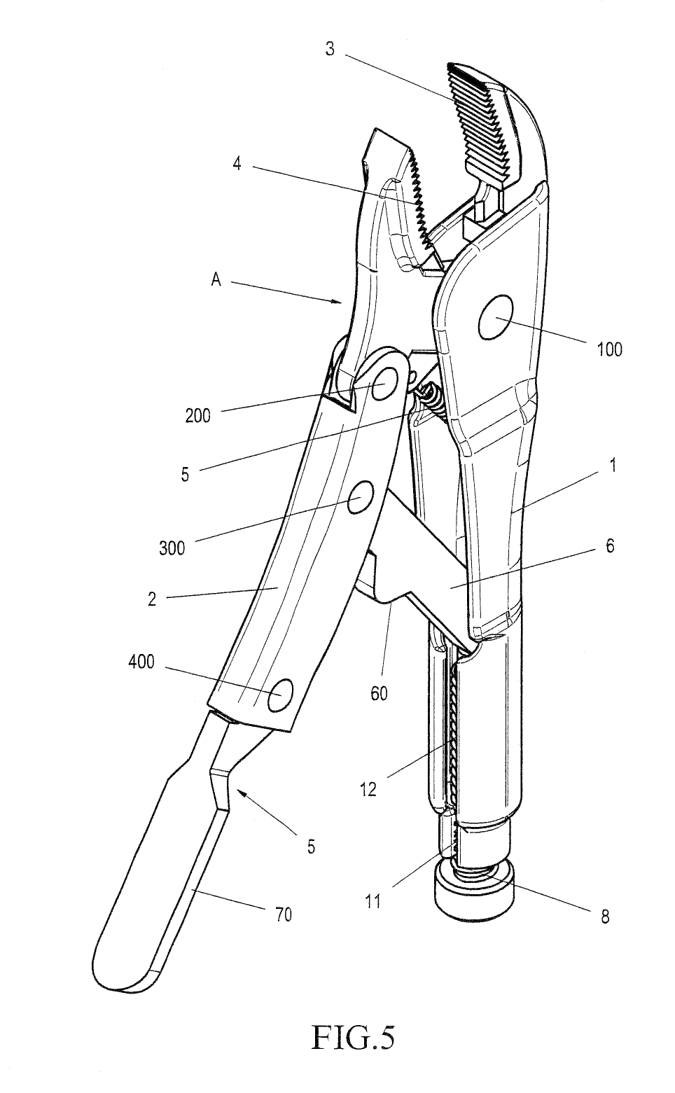

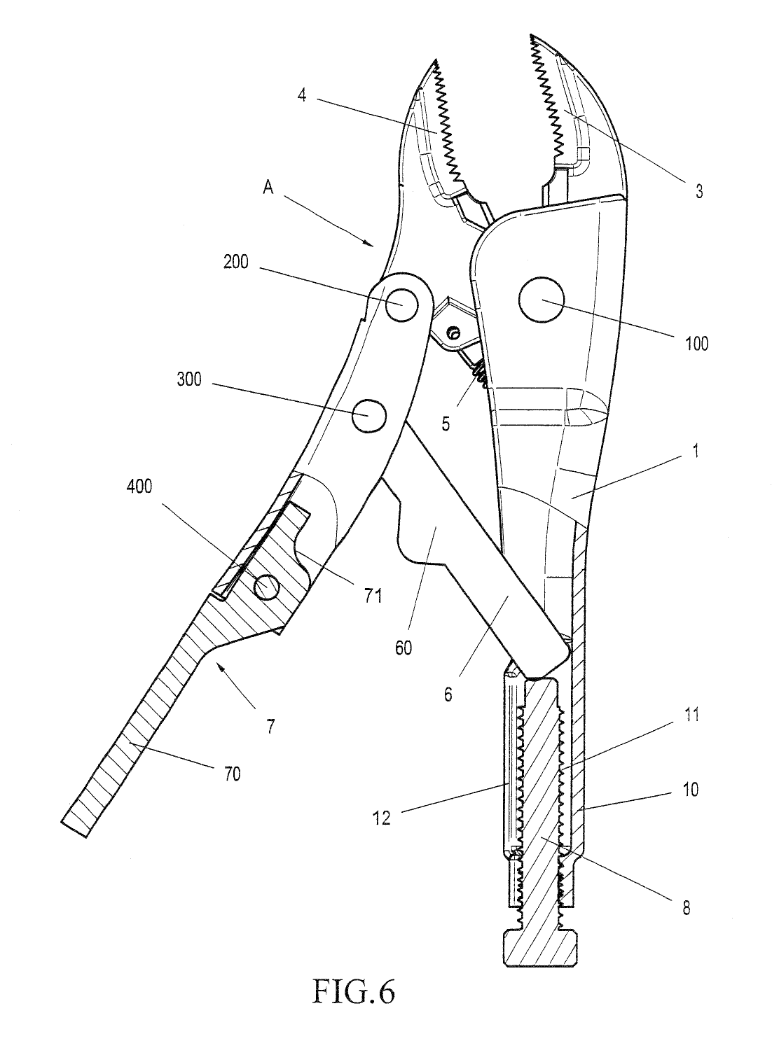

The second handle 2 of the pliers has a tail end that is riveted by a flat-head rivet 400 to the movable joint pulling and pushing mechanism 7. The pulling and pushing mechanism 7 has a movable pulling bar 70 that has a front end forming an arc recess 71 that is positioned against the middle projection 60 of the movable locking arm 6 that straddles between the first and second handles 1, 2 of the pliers, whereby the front-end arc recess 71 of the movable pulling bar 70 of the pulling and pushing mechanism 7, when pulled, undergoes a displacement that pushes away the middle projection 60 of the movable locking arm 6 that straddles between the first and second handles 1, 2 of the pliers to induce a reaction force that pushes away the second handle 2 to thereby release and open the second jaw 4 of the clamping mouth, as shown in FIGS. 5 and 6.

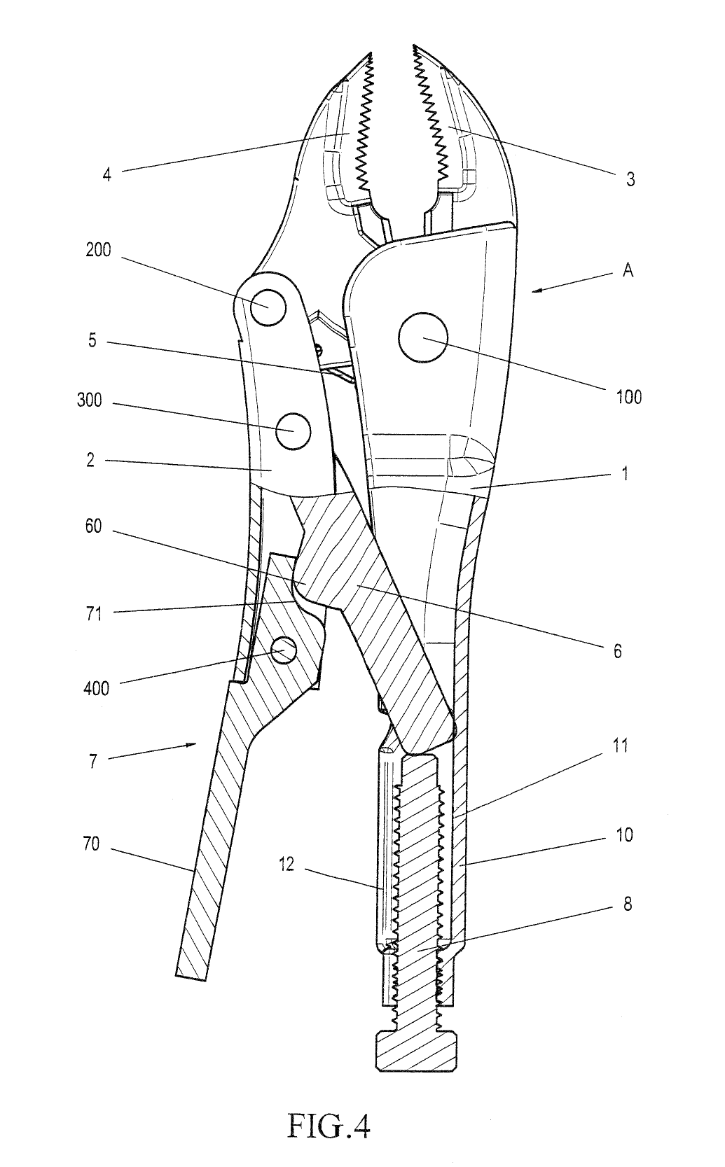

As such, when the first and second handles 1, 2 of the pliers are set in a clamped condition, in an attempt to release and open the first and second jaws 3, 4 of the front ends, the movable pulling bar 70 of the movable joint pulling and pushing mechanism 7 at the tail end of the second handle 2 of the pliers is directly pulled outwards, as shown in FIG. 4. Under this condition, the front-end arc recess 71 of the movable pulling bar 70 that is positioned against the middle projection of the movable locking aim 6 straddling between the first and second handles 1, 2 of the pliers is acted upon and pushed away by a reaction force of the movable pulling bar 70 to have the first and second handles 1, 2 opened and thus setting the first and second jaws 3, 4 at the front ends in an open condition, as shown in FIGS. 5 and 6, thereby realizing a fast and easy releasing and opening operation.

Referring to FIGS. 5 and 6, which are respectively a perspective view and a plan view, partially broken, of the pliers according to the present invention, the first and second jaws 3, 4 of the front ends of the pliers A form a clamping mouth that is openable by being pushed by a pulling operation of a movable joint pulling and pushing mechanism 7 that is directly riveted to the tail end of the second handle 2 to form a two-sectioned arrangement so as to realize a fast-operated pull-to-open operation.

In summary, the simple structure of locking pliers for releasing handles and jaws through fast and direct pulling provides a function of fast opening the mouth opening size of the front-end jaws of the pliers.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A simple structure of locking pliers for opening handles and jaws through fast and direct pulling, which comprises a control structure for fast opening the jaws of the locking pliers, the control structure for fast and direct pulling to push open the handles being characterized in that a tail end of a second handle of the pliers is provided, through riveting, with a movable joint pulling and pushing mechanism, the pulling and pushing mechanism comprising a movable pulling bar having a front end forming an arc recess that is curved in a plane on which the movable pulling bar moves, the recess being positioned against a middle projection of a movable locking arm straddling between the first and second handles of the pliers, the projection being shaped to correspond to the recess, whereby the front-end arc recess of the movable pulling bar of the pulling and pushing mechanism, when pulled, undergoes a displacement that pushes away the middle projection of the movable locking arm straddling between the first and second handles of the pliers to induce a reaction force that pushes away the second handle to thereby release and open the first and second jaws so as to fast and directly push for adjusting the push-to-open operation realized by the movable locking arm straddling between the first and second handles of the pliers thereby achieving an effect that opening of the jaws at front ends of the pliers is operated through being pushed by a pulling operation of the movable joint pulling and pushing mechanism that is arranged at a tail end of the second handle of the pliers to realize readily opening a clamping mouth of jaws.
